(19) United States
(12) Patent Application Publication
(10) Pub. No.: US 2008/0235337 A1
(43) Pub. Date: Sep. 25, 2008

(54) Adaptive buddy lists

(75) Inventors: Shantanu Sarkar, San Jose, CA (US); Ashish Chotai, Santa Clara, CA (US); Sravan Vadlakonda, Sunnyvale, CA (US); Aseem Asthana, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/726,050

(22) Filed: Mar. 21, 2007

(51) Int. Cl. G06F 15/16

(52) U.S. Cl. 709/206

(57) ABSTRACT

In one embodiment, a method can include: (i) monitoring for a buddy relevant event; (ii) deriving a buddy list portion from the buddy relevant event; (iii) determining presence information for each member in the buddy list portion; and (iv) updating an adaptive buddy list using the buddy list portion and the presence information.

### TECHNICAL FIELD

The present disclosure relates generally to text messaging, and involves management of “buddy” lists.

### BACKGROUND

In conventional text messaging (e.g., Instant Messenger (IM)) implementations, a buddy list is largely static, and managed manually. This approach may work well when people have a relatively small list, but as the number of people in the buddy list increases, it may be difficult to keep track of the people for manual management of the list. In addition, there may only be a small subset of buddies that a person wants to keep track of all the time, while for most contacts, relevance of a buddy may depend on a particular task being performed. For example, while preparing a presentation, the program manager and account teams for that presentation subject area may be relevant because the presenter may need to contact them at any time. However, the presence of these people may be largely irrelevant to that presenter at other times.

Some conventional approaches allow users to organize buddies into groups, but this mechanism is static and has little or no correlation to the actual activities in which a user is currently engaged. Other approaches utilize a document-centric presence approach, where e-mails and documents can display presence indications of an author or reviewers. However, because many modern corporate communications do not revolve around documents, this approach may have limited applications.

### BRIEF DESCRIPTION OF THE DRAWINGS

FIG. 1 illustrates an example adaptive buddy list management system.

FIG. 2 illustrates an example adaptive buddy list organization.

FIG. 3 illustrates an example buddy list portion with presence entry.

FIG. 4 illustrates a flow diagram of an example method of managing an adaptive buddy list.

### DESCRIPTION OF EXAMPLE EMBODIMENTS

### Overview

In one embodiment, a method can include: (i) monitoring for a buddy relevant event; (ii) deriving a buddy list portion from the buddy relevant event; (iii) determining presence information for each member in the buddy list portion; and (iv) updating an adaptive buddy list using the buddy list portion and the presence information.

In one embodiment, an apparatus can include: (i) a database configured to store an adaptive buddy list; and (ii) a server configured to: (a) receive a buddy relevant event indicator; (b) derive a buddy list portion from the buddy relevant event; (c) determine presence information for each member in the buddy list portion; and (d) update the adaptive buddy list using the buddy list portion and the presence information.

In one embodiment, a system can include: (i) a database configured to store an adaptive buddy list; (ii) a presence server coupled to the database, where the presence server can provide an updated buddy list to the database; (iii) a computer coupled to the presence server, where the computer can provide first activity information to the presence server; (iv) a call controller coupled to the presence server, where the call controller can provide second activity information to the presence server; and (v) an application server coupled to the presence server, where the application server can receive a buddy relevant event indication from the computer, and provide member information to the presence server.

### Example Embodiments

In particular embodiments, a dynamic buddy management approach may be utilized for devices, such as mobile endpoints, where it may not be feasible to manually update presence for everyone in the buddy list. Also, particular embodiments may not require an activity-specific presence for buddy list inclusion, such as one tied to particular document or e-mail types. In particular embodiments, buddies or members in a buddy list can be organized primarily in two types: (i) a statically assigned set of which a user may desire awareness across many or all activities; and (ii) a set of people relevant to specific tasks in which a user may be engaged. In addition to more traditional buddy list applications, push-to-talk (PTT) messaging and PTT buddy lists can also be supported in particular embodiments.

In particular embodiments, active tasks on a computer or processor can be considered as a buddy relevant event. A user reading e-mail may be a buddy relevant event, and the sender of the e-mail, or other people in the e-mail list (e.g., on the copy list), may be prospective members in a buddy list portion (e.g., a subset of a full buddy list). Other buddy relevant events and/or activities can include detection of tags in documents, since tagging may be used to mark any task. For example, combinations of tags, user history, and document information, can be used to determine appropriate presence for monitoring.

Some examples of tasks that can form dynamic presence groups include: (i) if one works on a bug tracking system, others interested in the particular bug being tracked can “bubble” up the messenger list; and (ii) in a call center environment, if a customer call is related to an issue in a particular document, all relevant call center agents for that department can be formed as a messenger group.

In particular embodiments, presence entities of interest may be derived from a different medium. For example, if a meeting is due to start, a person's buddy list can show the presence indication of everyone invited to the meeting. This can be a relatively fast way to determine if the meeting invitees are actually present, rather than having to log into a web interface, as in conventional approaches. In addition, particular embodiments may support presence via phone calls, video calls, or any other communications media and/or “modality.”

Particular embodiments can allow for: (i) managing of a buddy list; (ii) working across different media and multiple devices; (iii) determining potential members for presence monitoring, even if they are not currently in the buddy list; (iv) decreasing bandwidth used by presence updates across wireless and other low bandwidth connections; and (v) learning from user behavior to determine what presence entities are of interest.

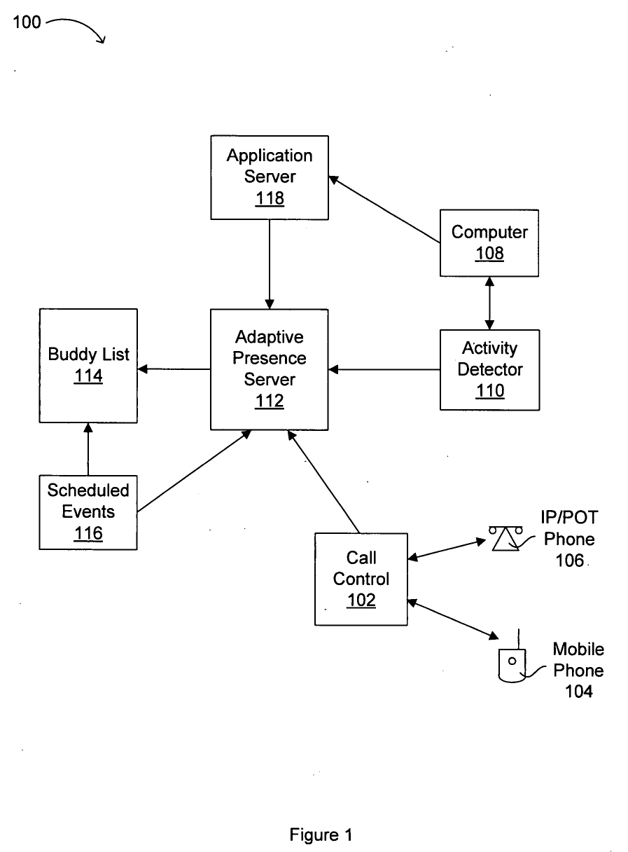

Referring now to FIG. 1, an example adaptive buddy list management system is shown and indicated by the general reference character 100. Call control 102 can interface with Internet protocol (IP)/plain old telephone (POT) phone 106, as well as mobile phone 104. Call control 102 can determine when a call is received at IP/POT 106 and/or mobile phone 104, and can send a list of participants on such a call to adaptive presence server 112.

As another example, for a call center (e.g., via call control 102), potential buddy list members derived from a customer call can include: an agent handling the call, specialists associated with the problem, and an engineer responsible for solving the customer's problem. Thus, a phone call can be one type of buddy relevant event, where potential buddy list members can be derived from participants in the call, or those that might be interested in the content of the call.

Computer 108 can also relay information to application server 118, which can receive other inputs from other applications as well. Application server 118 may include buddy list entries, or elements thereof, that can be supplied to adaptive presence server 112. Thus, adaptive presence server 112 can retrieve buddy list member information (e.g., contact information corresponding to a name) from application server 118. Alternatively, or in addition to, buddy list information may be stored directly with a client (e.g., in another computer and/or server).

Adaptive presence server 112 can include a traditional presence server in addition to an adaptive portion, for example. Alternatively, adaptive and traditional portions can be combined into one presence server structure. A traditional presence server may simply determine a current presence based on an input list of potential members of the buddy list. However, an adaptive presence server can dynamically update based on buddy list portions received in adaptive presence server 112. Also in particular embodiments, buddy list portions can be aggregated at adaptive presence server 112, and pushed to buddy list 114, for example.

Activity detector 110 can be used to detect current activity, short-term activity, active desktop considerations, activity patterns, applications running on computer 108, or any other appropriate buddy relevant event. Accordingly, activity may be detected depending on current activity, and not necessarily tied to a particular document. Activity detector 110 may report buddy relevant events detected in computer 108 to adaptive presence server 112, for example. Alternatively, or in addition to, computer 108 may report such events or other information to application server 118.

Activity detector 110 can also support “heuristic” event detection, where periodic activities or activity patterns can be considered. Thus, activities a person typically does, as well as activities involved in finding someone else's availability (e.g., checking another's availability 15 times per day), can be included in buddy relevant event determinations. In particular embodiments, the user can use time of day, history, or other related information to determine buddy relevance in a heuristic manner. For example, if Bob were to check with John twice a day on a customer problem, the system can learn to display John's presence information, even though it may be unrelated to the tasks in which Bob is currently engaged.

Scheduled events block 116 can include scheduled meetings, or any other time commitments for a user. In addition, a calendaring application can be utilized with scheduled events 116. For example, if a meeting is to start in five minutes, a status of others to be in that meeting may be displayed for the user. Thus, a presence update (e.g., via adaptive presence server 112) may be required for members prior to an update of buddy list 114.

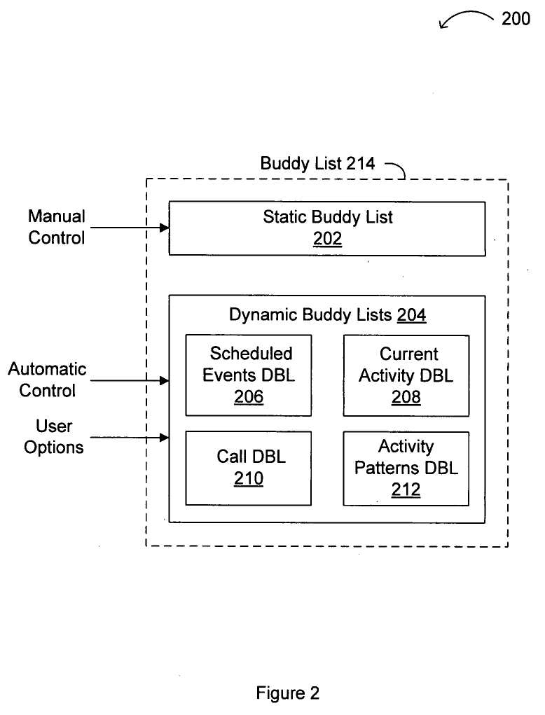

Referring now to FIG. 2, an example adaptive buddy list organization is shown and indicated by the general reference character 200. Buddy list 214 can include a static buddy list portion 202, as well as dynamic buddy lists 204. Static buddy list portion 202 can be configured by manual control, such as using conventional approaches for entering each buddy list member. Further, client extension over existing static approaches can be utilized for implementation of adaptive/dynamic buddy lists 204.

Static buddy list portion 202 may remain as is, while dynamic portion 204 can be updated via automatic control. Such automatic control can include any of the buddy relevant event detection approaches, and associated presence information, as discussed above with reference to FIG. 1. Dynamic buddy lists (DBL) 204 can include scheduled events DBL 206, current activity DBL 208, call DBL 210, and activity patterns DBL 212, as just a few examples.

User options can include control for aggregation of buddy list portions, and/or separation of one list from another. For example, buddy list 214 can be presented with personal lists separated from work-related lists, by separating out scheduled events (e.g., weekly meetings) from other lists, or by separating meeting list members for meetings that require attendance versus meetings where attendance is optional. Accordingly, user options can be utilized for aggregation and presentation control of received buddy list portions.

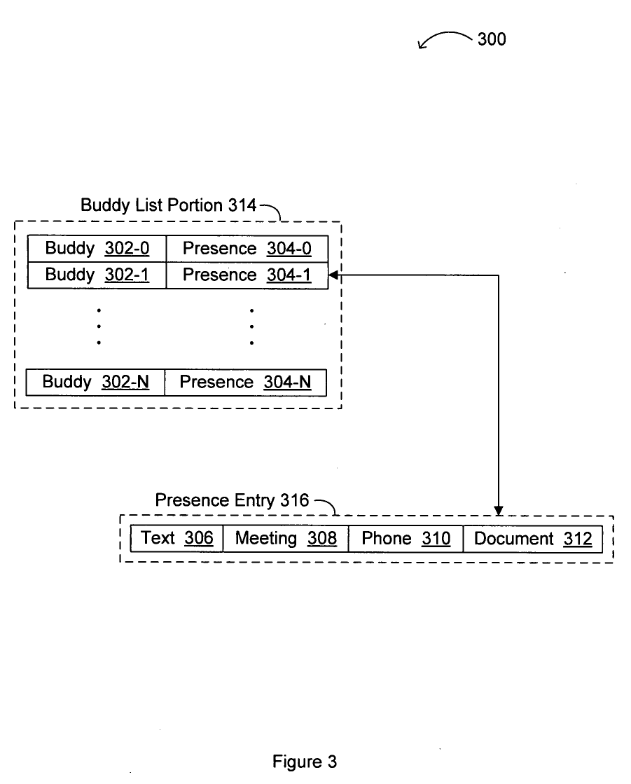

Referring now to FIG. 3, an example buddy list portion with presence entry is shown and indicated by the general reference character 300. As discussed above, presence can include availability indications, such as for a person involved in a meeting, or one available via e-mail. In particular embodiments, presence information can be enhanced to provide information in addition to basic presence information, as may be allowable by policy (e.g., a privacy policy). For example, “Bob is in the R&D review meeting via voice and Web.” Accordingly, information about Bob's physical presence and current activities may supplement his availability for communication in other modalities.

Buddy list portion 314 in FIG. 3 can include buddy entries 302-0, 302-1, . . . 302-N, and corresponding presence information 304-0, 304-1, . . . 304-N. Presence information can include information in a number of modalities, or any other appropriate ways of communication. For example, presence entry 316 can include text 306 (e.g., availability for text messaging), meeting 308 (e.g., availability for in-person or videoconference meeting), phone 310 (e.g., availability for a phone call), and document 312 (e.g., availability for a document review and/or collaborative editing). Accordingly, any suitable type of conferencing (e.g., web conferencing), phone calls (e.g., voice and/or video), or other ways of communicating, can be utilized in particular embodiments.

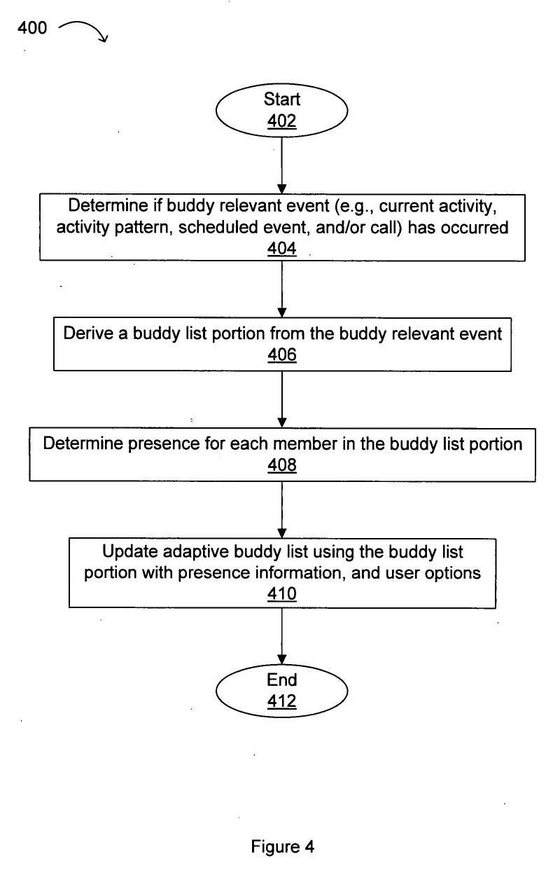

Referring now to FIG. 4, a flow diagram of an example method of managing an adaptive buddy list is shown and indicated by the general reference character 400. The flow can begin (402) and determination of whether a buddy relevant event has occurred can be made (404). For example, a buddy relevant event can include determinations of current activity, activity patterns, scheduled events, and/or phone calls. Particular embodiments can include using a component or function, such as a plug-in, for determining current activity and/or activity patterns.

A buddy list portion can be derived from the buddy relevant event (406). This derivation can include a determination of which potential buddy list members are considered to be relevant based on the event detected. Here, a user may provide criteria for making this derivation, such as by making a rule to never include a certain person on the user's buddy list. Once the buddy list portion is derived, a presence for each member in this buddy list portion can be determined (408). The adaptive buddy list can then be updated using the buddy list portion with presence information (410), and the flow can complete (412). User options, such as for aggregation of buddy list portion control, can also be included to guide adaptive buddy list formation.

Accordingly, particular embodiments can provide a mechanism for managing an adaptive buddy list. Further, particular embodiments can determine potential buddy list members by using current tasks, or communications in which the user may be engaged, through history, and other information.

Although the description has been described with respect to particular embodiments thereof, these particular embodiments are merely illustrative, and not restrictive. For example, while particular system structures and arrangements have been described, other structures and/or arrangements may be utilized in particular embodiments. Also, while specific examples of buddy list event determination characteristics, and the like, have been described, other criteria, etc., may be utilized in buddy list and/or presence determination in particular embodiments.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method, comprising:
monitoring for a buddy relevant event;
deriving a buddy list portion from the buddy relevant event;
determining presence information for each member in the buddy list portion; and
updating an adaptive buddy list using the buddy list portion and the presence information.

2. The method of claim 1, wherein the monitoring comprises using a component or function for determining current activity and/or activity patterns.

3. The method of claim 1, wherein the deriving the buddy list portion comprises accessing names involved in the buddy relevant event.

4. The method of claim 1, wherein the determining the presence information comprises determining an availability for each member in a plurality of modalities.

5. The method of claim 4, wherein the plurality of modalities comprises text communication.

6. The method of claim 4, wherein the plurality of modalities comprises video conference communication.

7. The method of claim 1, wherein the updating the adaptive buddy list comprises aggregating the buddy list portion with an existing buddy list.

8. An apparatus, comprising:
a database configured to store an adaptive buddy list; and
a server configured to:
receive a buddy relevant event indicator;
derive a buddy list portion from the buddy relevant event;
determine presence information for each member in the buddy list portion; and
update the adaptive buddy list using the buddy list portion and the presence information.

9. The apparatus of claim 8, wherein the buddy relevant event comprises a current activity.

10. The apparatus of claim 8, wherein the buddy relevant event comprises an activity pattern.

11. The apparatus of claim 8, wherein the buddy list portion is configured to be derived by accessing names involved in the buddy relevant event.

12. The apparatus of claim 8, wherein the presence information is configured to be determined by finding an availability for each member in a plurality of modalities.

13. The apparatus of claim 12, wherein the plurality of modalities comprises text communication.

14. The apparatus of claim 12, wherein the plurality of modalities comprises video conference communication.

15. A system, comprising:
a database configured to store an adaptive buddy list;
a presence server coupled to the database, the presence server being configured to provide an updated buddy list to the database;
a computer coupled to the presence server, the computer being configured to provide first activity information to the presence server;
a call controller coupled to the presence server, the call controller being configured to provide second activity information to the presence server; and
an application server coupled to the presence server, wherein the application server is configured to receive a buddy relevant event indication from the computer, and to provide member information to the presence server.

16. The system of claim 15, wherein the first activity information comprises an active desktop.

17. The system of claim 15, wherein the second activity information comprises a phone call.

18. The system of claim 15, wherein the database is configured on a client.

19. The system of claim 15, wherein the presence server is configured to determine an availability for each member in a plurality of modalities.

20. The system of claim 19, wherein the plurality of modalities comprises text communication and videoconferencing.
